(19) United States
(12) Patent Application Publication
(10) Pub. No.: US 2003/0083950 A1
(43) Pub. Date: May 1, 2003

(54) Marketing methods for reoccurring internet based game revenues

(76) Inventor: Gregory R. Ofiesh, Tracy, CA (US)

Correspondence Address: Gregory R. Ofiesh, 2931 San Rocco Court, Tracy, CA, 95376, US

(21) Appl. No.: 10/000,966

(22) Filed: Oct. 31, 2001

(51) Int. Cl. G06F 17/60

(52) U.S. Cl. 705/26

(57) ABSTRACT

A method of generating reoccurring revenues through the sale of game tokens for Internet or other network based games. The method provides Internet based game vendors with self advertising software. The free acquisition of the software accelerates the distribution among the consumer base and eliminates software piracy.

### BACKGROUND—FIELD OF INVENTION

This invention relates to Internet based game business strategies, specifically reoccurring revenue marketing processes.

### BACKGROUND—DESCRIPTION OF PRIOR ART

The Internet is widely known as a publicly accessible global computer network. The Internet provides government, business, personal, and educational computer systems a common medium for communications. Business transactions based in part or in whole on the Internet are just beginning to evolve from their infancy stage. e-business is a relatively new term that denotes business transactions performed over the Internet.

Two business models are predominate on the Internet: purchase of product, and purchase of service. A consumer can purchase a product from a web site in a similar fashion as a telephone from a telephone company's retail outlet. A consumer can also purchase the services of a web site in a similar fashion as a telephone service from a telephone company.

Purchasing a software application over the Internet is similar to purchasing the same product in a box at a computer store. The consumer obtains a copy of the software and owns a license to use the software. Software purchased in a box at a store is quite often on a CD ROM. Software purchased over the Internet is quite often downloaded directly to the consumer's computer.

Purchasing a software application in a service oriented model is new. The industry recognizes the reoccurring revenue that this model produces as the Holy Grail of e-business. This model is becoming more widely utilized in Internet based application rentals, and is the basis of Microsoft's. NET initiative.

Generally, Internet based games are purchased (the user buys a license for use of the software); there is no financial cost to play the game. The Internet based games industry has failed to successfully develop a useful reoccurring revenue business model. When applying the application rental model to games, consumers are turned off with the huge costs incurred by lengthy and multiple games. And when attempting to demonstrate the game, the game vendor must retard the features of the game or severely limit the demo play time to avoid free play by consumers who are unwilling to pay.

Internet based games are generally purchased, rather than being freely made available. This leads to pirated copies by people wanting something for nothing. Pirated copies of a CD ROM are readily done these days with the advent of CD-Writers on home PCs. This is a weakness in the current one time purchase model of software in general.

### SUMMARY

A method to implement a reoccurring revenue business model for Internet based games, based upon the purchase of game tokens, for a generally otherwise free game.

### OBJECTS AND ADVANTAGES

Accordingly, several objects and advantages of my method are:

(a) to shift revenue generation from one time purchases of game software licenses to reoccurring purchases of tokens, game pieces that are used in the play of the game;

(b) to give game vendors the ability to freely and massively distribute their software to the general public, accelerating distribution among the consumer base;

(c) to give game vendors the flexibility to offer nearly endless demo play time without retarding game features or play time;

(d) and, to eliminate software piracy.

Still further objects and advantages will become apparent from a consideration of the ensuing description and drawings.

### DRAWING FIGURES

The accompanying drawings, which are incorporated in and constitute a part of this specification, illustrate both the prior art and a preferred embodiment of my method and together with the general description given above and the detailed description given below, serve to explain the principles of my method.

FIG. 1 shows a logic diagram of a client component, a game service, a game token, and a communication path between the client component and game service.

FIG. 2 shows a logic diagram of a client component, a game service, a token service, a free game token, expensive game token, and communication paths between the client component, the game service, and the token service.

FIG. 3 shows a logical layout of a consumer's client personal computer, a game server, a token server, and the network connections between them.

### REFERENCE NUMERALS IN DRAWINGS

10 Network

10H Network Connection

11 Network

11H Network Connection

12 Client Component

12H Client Personal Computer

13 Game Service

13H Game Server

14 Token Service

14H Token Server

15f Free Token

15p Expensive Token

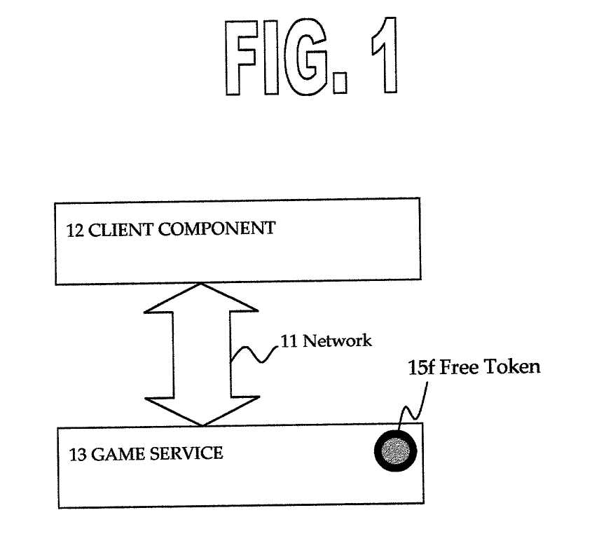

### Description—FIG. 1—Prior Art

FIG. 1 is a logical diagram which depicts a common prior art architecture for network based games.

The consumer uses the client component 12 to play a game. The client component 12 runs on the consumer's personal computer or other computing device. The game is hosted on a server which runs the game service 13. Communications between the client component and the game service are facilitated over a network 11, such as the Internet.

The financial costs of hosting a server to run the game service 13 is generally bore by consumers to increase profitability by the game vendors. A game service 13 plays at least one instance of the game.

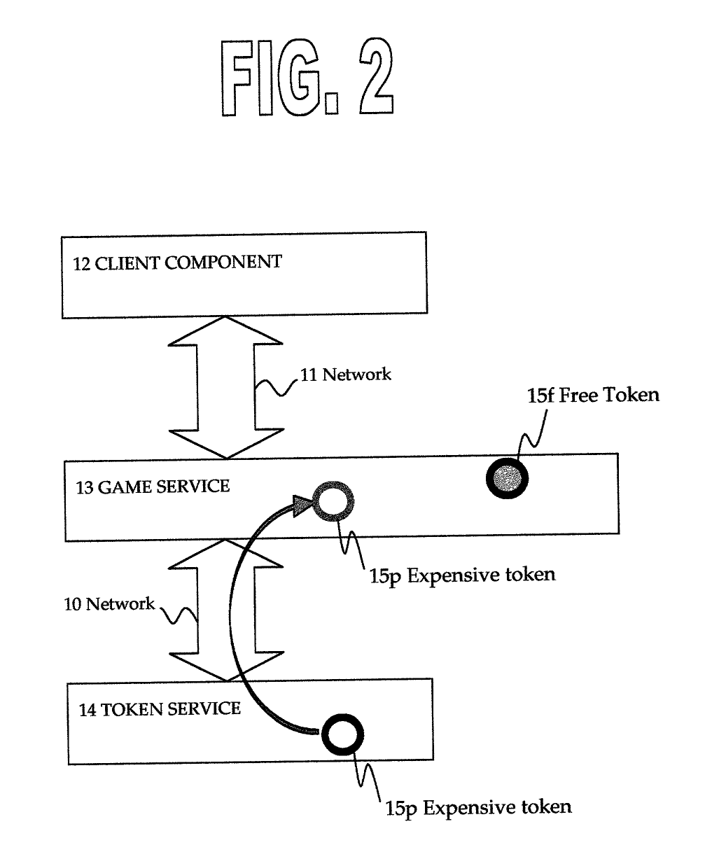

### FIG. 2—Logical Diagram of Software Architecture of Preferred Embodiment

FIG. 2 is a logical diagram which depicts a generalized architecture for network based games as a preferred embodiment of my method.

The consumer uses the client component 12 to play a game. The client component 12 runs on the consumer's personal computer or other computing device. The game is hosted on a server which runs the game service 13. Communications between the client component and the game service are facilitated over a network 11, such as the Internet.

The financial costs of hosting a server to run the game service 13 is generally bore by consumers to increase profitability by the game vendors. A game service 13 plays at least one instance of the game.

A token service 14 communicates with the game service 13 over a network 10. The token service 14 is used to generate and manage game tokens that consumers purchase for use in playing the game. The free token 15f is generated and managed by the game service 13. The expensive token 15p is generated and managed by the token service 14. The playing of the expensive token 15p is managed by the game service 13. The expensive token 15p must be coordinated between the game service 13 and the token service 14.

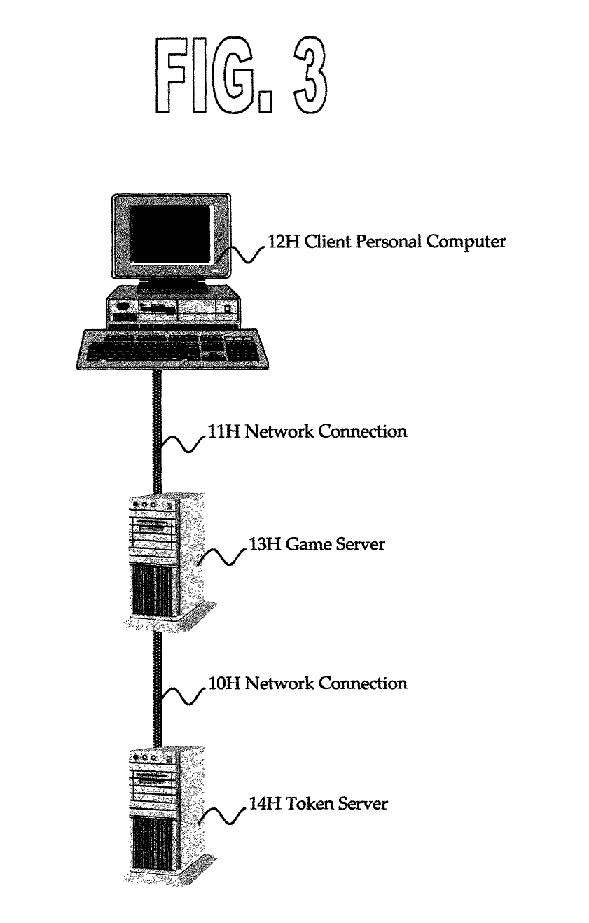

### FIG. 3—Logical Diagram of Hardware Layout of Preferred Embodiment

FIG. 3 shows a logical diagram of hardware layout representative of the preferred embodiment of my method.

The consumer installs a client component 12 onto a client personal computer 12H. The client component 12 on the client personal computer 12H communicates with a game service 13 running on a game server 13H over a network connection 11H.

The game service 13 running on the game server 13H communicates with a token service 14 running on a token server 14H over a network connection 10H.

### Advantages

From the description above, a number of advantages of my method become obvious.

The prior art is built upon, rather than completely scrapped. Many games available today can be modified to utilize the present invention.

Reoccurring revenue is found in the reoccurring purchases of expensive tokens 15p, facilitated by the token service 14.

Game software may be freely downloaded and played by a consumer, which will accelerate the distribution into the consumer market base, inherently produce a free and powerful advertisement tool, and eliminate software piracy.

### Operation

In FIG. 1, a consumer installs and runs the client component 12 onto their personal computer or other computing device. The consumer and/or client component 12 determine which game service 13 the client component 12 will connect to by means of a network 11.

The consumer plays the game with only free tokens 15f which are generated and managed by the game service 13.

In FIG. 2, a consumer installs and runs the client component 12 onto their personal computer or other computing device. The consumer and/or client component 12 determine which game service 13 the client component 12 will connect to by means of a network 11.

The consumer plays the game to the extent possible according to the game's design. Tokens are used to play the game. Tokens may be free or may require purchasing.

A consumer plays the game with free tokens 15f which are generated and managed by the game service 13. The consumer may purchase an expensive token 15p. An expensive token is generated and managed by a token service 14. The playing of the expensive token 15p is managed by the game service 13. The token service 14 communicates with the game service 13 by means of a network 10.

An expensive token may also be given freely to a consumer by the game vendor as a marketing strategy, such as a promotional offer.

Consumers may purchase any expensive token 15p they desire, according to the design of the game. The game software or supporting software provide the means to communicate to the consumer the prices for, and availability of, various expensive tokens 15p. The client component 12 offers the consumer a mechanism to purchase expensive tokens 15p from the token service 14 by way of the game service 13.

The game service 13 maintains awareness of tokens under its control.

In FIG. 3, a consumer installs and runs the client component 12 onto their client personal computer 12H. The client component 12 running on the client personal computer 12H communicates with the game service 13 running on the game server 13H over a network connection 11H.

The token service 14 running on the token server 14H communicates with the game service 13 running on the game server 13H over a network connection 10H.

Generation of expensive tokens 15p is performed on the token server 14H, but the playing of the expensive token 15p is performed on the game server 13H.

The consumer interacts with both the game service 13 and the token service 14 by means of the client component 12.

### CONCLUSION, RAMIFICATIONS, AND SCOPE

Accordingly, the reader will see that my method will:

(a) increase the usefulness of the Internet for commercial gain;

(b) help e-business evolve and mature by introducing a new marketing model;

(c) provide some prior art Internet based games with a forward and cost effective evolutionary path;

(d) provide game vendors with a powerful advertising tool in the game software itself,

(e) accelerate the distribution of the software among the consumer base;

(f) eliminate software piracy;

(g) and increase the profits of the game vendors through utilizing the more desirable reoccurring revenue model.

A game vendor may choose to use expensive tokens as the exclusive source of revenue, or as one of several sources of revenue.

A game vendor may choose to limit the feature or play time of a game due to purchase patterns of a consumer, such as how much money the consumer spends on purchasing expensive tokens 15p, or which types of expensive tokens 15p are purchased by the consumer.

A game may be designed to limit the life of expensive tokens 15p to the instance of the game the expensive tokens 15p were purchased. Or the token service 14 may give persistence to expensive tokens 15p so the expensive tokens 15p remain associated with, or possessed by, a consumer after the conclusion of one game for use in a later instance of the game.

An expensive token 15p may be designed to be consumed after a specific length of game play (even if the length of game play spans several games), a specific number of games, or a specific number of uses.

A game's design may allow for combining some services onto a single server.

A game's design or deployment may include farms of servers that appear as a single server.

A game's deployment may include dusters of servers.

An expensive token 15p may be managed in other ways, such as partially by the client component 12 and partially by a token service 14.

A free token may be managed in other ways, such as partially by the game service 13 and partially by the client component 12.

I claim:

1. A method of producing reoccurring revenue by means of a game, comprising
(a) providing a consumer acquires said game in the form of computer software,
(b) providing tokens are used in the play of said game to realize functionality and features,
(c) offering at least one expensive token to said consumer by selling the token,
(d) offering any number of free tokens to said consumer by allowing the acquisition of said tokens at no financial cost to said consumer,
(e) offering multiple player game competition against other consumers to said consumer,
whereby the revenue is generated at least in part upon the sales of at least one said expensive token to at least one said consumer.

2. The method in claim 1 wherein said expensive token purchased by said consumer is persistent and associated with said consumer,
(a) offering said consumer the choice of at least one instance of said game in which to play said token,
whereby said token is potentially available for use in later instances of said game.

3. The method in claim 1 wherein said game is licensed and acquired at some financial cost to said consumer,
whereby the revenue is based partly on said sale of at least one said expensive token and partly on the licensing and acquisition of said game software.

4. The method in claim 1 wherein said game is licensed to, and acquired by, said consumer at no financial cost,
(a) providing said game is playable by said consumer at no financial cost, save special game functionality and features provided to said consumer by the use of said expensive tokens in the course of playing said game,
whereby said game provides advertisement and luring temptation to said consumer by means of offering said consumer almost unlimited, free, and negligibly retarded game play.

5. The method in claim 1 wherein a game service is hosted exclusively by a game vendor.

6. The method in claim 1 wherein a game service is hosted by anyone, including both game vendors and consumers.

7. The method in claim 1 wherein a token service and a game service are combined onto one server,
whereby the use of the servers' hardware can be optimized for cost, use, or performance.

8. The method in claim 1 wherein a token service and/or a game service is split among many servers,
whereby the use of the servers' hardware can be optimized for cost, use, or performance.
